(19) United States
(12) Patent Application Publication
(10) Pub. No.: US 2024/0192961 A1
(43) Pub. Date: Jun. 13, 2024

(54) PROCESSOR INSTRUCTION EXCEPTION HANDLING

(71) Applicant: Akeana, Inc., San Jose, CA (US)

(72) Inventors: Ricardo Ramirez, Sunnyvale, CA (US); Rabin Sugumar, Sunnyvale, CA (US)

(73) Assignee: Akeana, Inc., San Jose, CA (US)

(21) Appl. No.: 18/530,409

(22) Filed: Dec. 6, 2023

Related U.S. Application Data
(60) Provisional application No. 63/547,574, filed on Nov. 7, 2023.
(60) Provisional application No. 63/547,404, filed on Nov. 6, 2023.
(60) Provisional application No. 63/546,769, filed on Nov. 1, 2023.
(60) Provisional application No. 63/545,961, filed on Oct. 27, 2023.
(60) Provisional application No. 63/542,797, filed on Oct. 6, 2023.
(60) Provisional application No. 63/526,009, filed on Jul. 11, 2023.
(60) Provisional application No. 63/521,365, filed on Jun. 16, 2023.
(60) Provisional application No. 63/471,283, filed on Jun. 6, 2023.
(60) Provisional application No. 63/467,335, filed on May 18, 2023.
(60) Provisional application No. 63/463,371, filed on May 2, 2023.
(60) Provisional application No. 63/462,542, filed on Apr. 28, 2023.
(60) Provisional application No. 63/444,619, filed on Feb. 10, 2023.
(60) Provisional application No. 63/439,761, filed on Jan. 18, 2023.
(60) Provisional application No. 63/436,133, filed on Dec. 30, 2022.
(60) Provisional application No. 63/436,144, filed on Dec. 30, 2022.
(60) Provisional application No. 63/435,831, filed on Dec. 29, 2022.
(60) Provisional application No. 63/435,343, filed on Dec. 27, 2022.
(60) Provisional application No. 63/434,104, filed on Dec. 21, 2022.
(60) Provisional application No. 63/431,756, filed on Dec. 12, 2022.
(60) Provisional application No. 63/430,700, filed on Dec. 7, 2022.
(60) Provisional application No. 63/602,514, filed on Nov. 24, 2023.
(60) Provisional application No. 63/605,620, filed on Dec. 4, 2023.

(51) Int. Cl. G06F 9/38

(52) U.S. Cl. CPC G06F 9/3861

(57) ABSTRACT

Techniques for instruction execution based on processor instruction exception handling are disclosed. A processor core is accessed. The processor core executes at least one instruction thread. The processor core executes one or more instructions out of order. An ordered list of instructions is maintained. The ordered list is based on instructions that are presented to the processor core for execution. The ordered list is organized using one or more pointers. An execution exception is detected in the processor core. The execution exception corresponds to one of the instructions in the ordered list. The execution exception requires initiating an exception handling routine. An effective age of an instruction in the ordered list is determined. The effective age corresponds to the execution exception. The exception handling routine is initiated, based on matching the effective age of an instruction in the ordered list with one of the one or more pointers.

### RELATED APPLICATIONS

This application claims the benefit of U.S. provisional patent applications “Processor Instruction Exception Handling” Ser. No. 63/430,700, filed Dec. 7, 2022, “Branch Target Buffer Operation With Auxiliary Indirect Cache” Ser. No. 63/431,756 filed Dec. 12, 2022, “Processor Performance Profiling Using Agents” Ser. No. 63/434,104, filed Dec. 21, 2022, “Prefetching With Saturation Control” Ser. No. 63/435,343, filed Dec. 27, 2022, “Prioritized Unified TLB Lookup With Variable Page Sizes” Ser. No. 63/435,831, filed Dec. 29, 2022, “Return Address Stack With Branch Mispredict Recovery” Ser. No. 63/436,133, filed Dec. 30, 2022, “Coherency Management Using Distributed Snoop” Ser. No. 63/436,144, filed Dec. 30, 2022, “Cache Management Using Shared Cache Line Storage” Ser. No. 63/439,761, filed Jan. 18, 2023, “Access Request Dynamic Multilevel Arbitration” Ser. No. 63/444,619, filed Feb. 10, 2023, “Processor Pipeline For Data Transfer Operations” Ser. No. 63/462,542, filed Apr. 28, 2023, “Out-Of-Order Unit Stride Data Prefetcher With Scoreboarding” Ser. No. 63/463,371, filed May 2, 2023, “Architectural Reduction Of Voltage And Clock Attach Windows” Ser. No. 63/467,335, filed May 18, 2023, “Coherent Hierarchical Cache Line Tracking” Ser. No. 63/471,283, filed Jun. 6, 2023, “Direct Cache Transfer With Shared Cache Lines” Ser. No. 63/521,365, filed Jun. 16, 2023, “Polarity-Based Data Prefetcher With Underlying Stride Detection” Ser. No. 63/526,009, filed Jul. 11, 2023, “Mixed-Source Dependency Control” Ser. No. 63/542,797, filed Oct. 6, 2023, “Vector Scatter And Gather With Single Memory Access” Ser. No. 63/545,961, filed Oct. 27, 2023, “Pipeline Optimization With Variable Latency Execution” Ser. No. 63/546,769, filed Nov. 1, 2023, “Cache Evict Duplication Management” Ser. No. 63/547,404, filed Nov. 6, 2023, “Multi-Cast Snoop Vectors Within A Mesh Topology” Ser. No. 63/547,574, filed Nov. 7, 2023, “Optimized Snoop Multi-Cast With Mesh Regions” Ser. No. 63/602,514, filed Nov. 24, 2023, and “Cache Snoop Replay Management” Ser. No. 63/605,620, filed Dec. 4, 2023.

Each of the foregoing applications is hereby incorporated by reference in its entirety.

### FIELD OF ART

This application relates generally to instruction execution and more particularly to processor instruction exception handling.

### BACKGROUND

Integrated circuits, or “chips”, are found in a dizzying array of common and specialty products. The products target personal, domestic, lifestyle, and transportation applications, among many, many more. The personal products that contain chips can include personal care and daily hygiene items such as electric toothbrushes. Unlike their manual counterparts that are limited by the skill and attention of the user, electric toothbrushes can enhance dental hygiene by offering a variety of speeds and brushing actions. Integrated circuits are now common in many domestic items such as kitchen appliances. These kitchen appliances now offer features that exceed mere speed control, instead offering options that can bake bread or even prepare foods that require advanced kitchen skills. The lowly thermostat has advanced beyond a rudimentary temperature operated on-off switch. Now, thermostats contain integrated circuits so that the thermostats learn occupant usage patterns of various rooms within a house, office, or school. The thermostats can also enter an “eco” mode which reduces heating and cooling costs by conserving energy usage. Integrated circuits enhance all of these previously limited capability devices to make them far more capable, useful, and even fun.

Integrated circuits are known by consumers to be present in electronic devices including smartphones, tablets, televisions, laptop and desktop computers, gaming consoles, and more. The chips not only enable but also greatly enhance device features and utility. These enhanced device features render the devices far more useful and essential to the users' lives than earlier device versions. Toys and games have greatly benefited from added integrated circuits. The chips are used to better engage players ranging from “first timers” to battle-hardened gaming veterans. Further, the chips are used to produce remarkably realistic audio and graphics, enabling players to immerse themselves in exotic digital worlds and gaming scenarios. The games support single participant and team play, encouraging players to join together to participate. The chip-enhanced games can even enable players to join the competition from locations around the world. The players can don virtual reality headsets, enabling them to be immersed in virtual worlds, surrounded by computer generated graphics and 3D audio.

Integrated circuits are found in vehicles of all types. As new features are added to the vehicles, increasing numbers of chips can be used. The chips control and improve fuel economy and vehicle operating efficiency, vehicle safety, user comfort, and user entertainment. The integrated circuits are found in vehicles ranging from manually operated ones to semiautonomous and autonomous vehicles. Vehicle safety features include proximity to other vehicles, vehicle drifting, and even driver status. The chips can be used to allow or prevent user access to the vehicle, and even to take over operation of the vehicle if the user falls asleep or has a medical emergency. The integrated circuits found in these widely ranging devices and applications greatly enrich overall user experience by adding desirable features that were previously unavailable.

### SUMMARY

Processors of various types are found in devices ranging from personal electronic devices such as cellphones and computers, to specialty devices including medical equipment, to household appliances, and to vehicles, among many other applications. The processors enable the devices that house the processors to provide a wide variety of useful and entertaining applications. The applications include data processing, messaging, patient monitoring, telephony, access to and operational control of a vehicle, etc. The processors are coupled to additional elements that enable and enhance processor performance as the processors execute their assigned applications. The additional elements typically include one or more of shared, common memories, communications channels, test features, security features, peripherals, and so on. At times, a processor can encounter a problem or exception as the processor executes an instruction. The problem can include that data required by the instruction does not arrive in time for the instruction to process the data, processing the data generates an error such as an overflow error, the instruction is an invalid or illegal instruction, the instruction is a privileged instruction, among other exceptions. As a result of the occurrence of the exception, an exception handling routine can be initiated. The exception handling routine can execute a special set of instructions to address the exception.

A processor core is used to execute instructions associated with at least one instruction thread. The instructions associated with the instruction thread are contained within a maintained, ordered list of instructions. The ordered list of instructions is maintained in a circular buffer. One or more pointers are used to maintain the ordered list of instructions in a circular queue. The instructions within the ordered list of instructions can be accessed and executed in order or out of order. The out-of-order execution occurs when data required by an instruction becomes available and execution of the instruction can proceed. During execution of an instruction, an execution exception can occur. The exception can include a data access exception such as an access timeout, an arithmetic exception such as arithmetic overflow, an undefined instruction, and so on. The detected execution exception requires that an exception handling routine be initiated. The exception handling routine can be initiated based on matching an effective age of an instruction in the ordered list with one of the pointers. The exception handling routine can be delayed without using data stored in a buffer such as a reorder buffer. The delaying can enable instructions not associated with the exception to complete, can allow valid data to be stored, and so on.

Instruction execution is enabled by processor instruction exception handling. A processor-implemented method for instruction execution is disclosed comprising: accessing a processor core, wherein the processor core executes at least one instruction thread, and wherein the processor core executes one or more instructions out of order; maintaining an ordered list of instructions, wherein the ordered list is based on instructions that are presented to the processor core for execution, and wherein the ordered list is organized using one or more pointers; detecting an execution exception in the processor core, wherein the execution exception corresponds to one of the instructions in the ordered list, and wherein the execution exception requires initiating an exception handling routine; determining an effective age of an instruction in the ordered list that corresponds to the execution exception; and initiating the exception handling routine, based on matching the effective age of an instruction in the ordered list with one of the one or more pointers. In embodiments, the ordered list of instructions is maintained in a circular queue. In embodiments, the one or more pointers that are used to organize the ordered list comprise a head pointer and a tail pointer within the circular queue. And in embodiments, the tail pointer indicates a youngest, non-retired instruction in the ordered list of instructions.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for processor instruction exception handling.

FIG. 2 is a flow diagram for exception handling.

FIG. 3 is a system block diagram showing a processor core with exception handling.

FIG. 4 is a block diagram illustrating a RISC-V processor.

FIG. 5 is a block diagram for a pipeline.

FIG. 6 is an example flow for instruction handling.

FIG. 7 is a system diagram for processor exception handling.

### DETAILED DESCRIPTION

Techniques for instruction execution are enabled using processor instruction exception handling. A processor such as a standalone processor, a processor chip, a processor core, and so on can be used to perform data processing tasks. The data processing can be significantly enhanced by using two or more processors to process the data. The processors can be performing substantially similar operations, where the processors can process different portions or blocks of data in parallel. The processors can be performing substantially different operations, where the processors can process different blocks of data or may try to perform different operations on the same data. Whether the operations performed by the processors are substantially similar or not, managing how processors execute instructions, access data, and manage data in unprocessed or processed states is critical to successfully processing the data. Further, the data must be available to an instruction being executed by the processor in a timely manner, or an exception occurs. The exception can be based on a memory access timeout in which data did not arrive in time. Further exceptions can be based on processing errors such as arithmetic overflows, invalid or illegal instructions, attempts to execute privileged instructions, and so on.

The processor core can access and execute instructions within the ordered list of instructions using the one or more pointers. The instructions can be executed in order based on the ordered list of instructions, can execute the instructions out of order, or can execute instructions both in order and out of order. The out-of-order execution can be based on availability of data required by a given instruction. When the required data becomes available, then the instruction can be executed. While out-of-order execution can enhance overall data processing throughput of the processor core, an instruction execution exception can be detected by the processor core while executing an instruction. The execution exception can be associated with in-order execution or out-of-order execution, based on which instruction caused the instruction execution error. To identify which instruction caused the exception, an effective “age” of an instruction can be determined. The age of the instruction is based on when the instruction was added to the ordered list of instructions. That is, instructions that were added earlier are older than instructions that were added later.

The ordered list of instructions is organized using one or more pointers, and the ordered list is maintained in a circular queue. The one or more pointers that are used to organize the ordered list include a head pointer and a tail pointer within the circular queue. The pointers point to addresses within the queue. The effective age of an instruction within the ordered list of instructions corresponds to an address (e.g., position) within the circular queue. Since the address within the circular queue is relative to a pointer, the effective age of the instruction in the ordered list is established by comparison to the head pointer. Thus, the identification of the instruction that caused an execution exception can be based on determining the effective age of the instruction and matching the effective age of an instruction in the ordered list with one of the one or more pointers. The match of the effective age of the instruction in the ordered list is established by comparison to the head pointer. The comparison to the head pointer can be based on an equality, on a value one less than the oldest instruction, and so on.

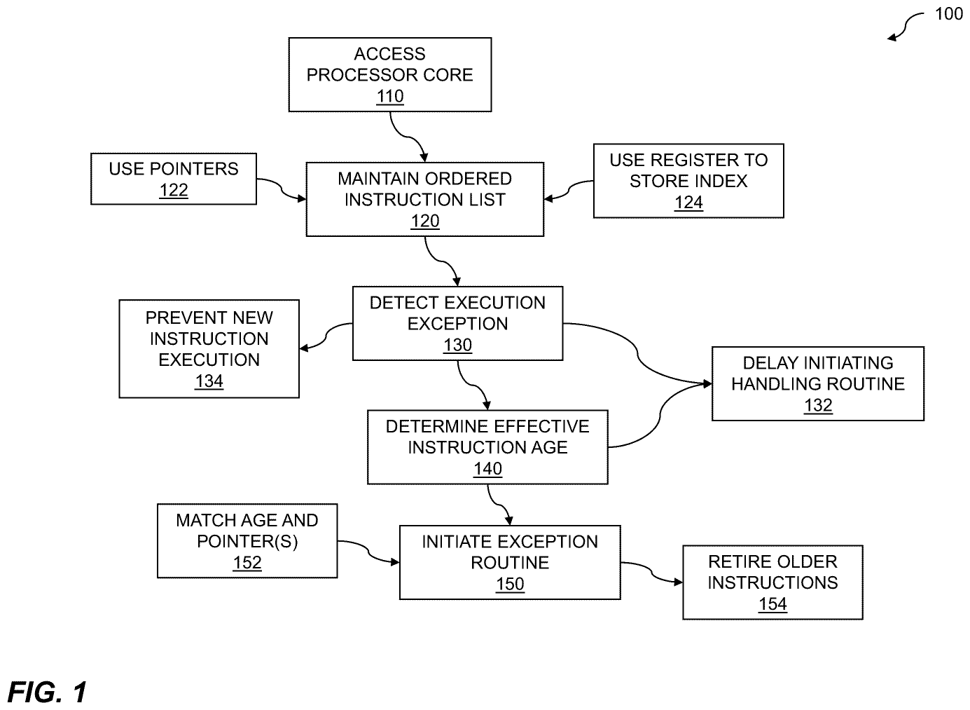

FIG. 1 is a flow diagram for processor instruction exception handling. The processor instruction exception handling can be associated with a processor core. A processor core can include a processor core within a multicore processor such as a RISC-V™ processor. The processor cores can include homogeneous processor cores or heterogeneous processor cores. The cores that are included can have substantially similar capabilities or substantially different capabilities. The processor cores can include or be coupled to further elements. The further elements can include one or more of physical memory protection (PMP) elements, memory management (MMU) elements, level 1 (L1) caches such as instruction caches and data caches, level 2 (L2) caches, and the like. The multicore processor can further include a level 3 (L3) cache, test and debug support such as joint test action group (JTAG) elements, a platform level interrupt controller (PLIC), an advanced core local interrupter (ACLINT), and so on. In addition to the elements just described, the multicore processor can include one or more interfaces. The interfaces can include one or more industry standard interfaces, interfaces specific to the multicore processor, and the like. In embodiments, the interfaces can include an Advanced extensible Interface (AXI™) such as AXI4™, an ARM™ Advanced extensible Interface (AXI™) Coherence Extensions (ACE™) interface, an Advanced Microcontroller Bus Architecture (AMBA™) Coherence Hub Interface (CHI™), etc. The interfaces can enable connection between the multicore processor and an interconnect. In embodiments, the interconnect can include an AXI™ interconnect. The interconnect can enable the multicore processor to access a variety of peripherals such as storage elements, communications elements, etc.

The flow 100 includes accessing a processor core 110. The processor core can comprise a processor core within a plurality of processor cores. The processor cores can include homogeneous processor cores, heterogeneous processor cores, and so on. The cores can include general purpose cores, specialty cores, custom cores, etc. In embodiments, the cores can be associated with a multicore processor such as a RISC-V™ processor. The cores can be included in one or more integrated circuits or “chips”, application-specific integrated circuits (ASICs), programmable gate arrays (PGAs), and the like. In embodiments, the processor core executes one or more instructions out of order. Out-of-order execution can include executing an instruction as soon as possible, based on availability of data required by the instruction. In embodiments, each processor of the plurality of processor cores can access a common memory. The common memory can include a memory comprising one or more integrated circuits, a memory colocated with the plurality of processor cores in an arrangement such as a system on chip (SoC), etc. The common memory can include a single port memory, a multiport memory, and the like. In embodiments, access to the common memory is accomplished through a network-on-chip. The network-on-chip can include a coherent network-on-chip. A network-on-chip can comprise a subsystem, on an integrated circuit, that can be used to enable communications among various elements on a system-on-chip.

The flow 100 includes maintaining 120 an ordered list of instructions. The instructions can include instructions associated with an instruction thread. The ordering of the instructions in the list can be based on precedence, priority, order of execution, and the like. In embodiments, the ordered list is based on instructions that are presented to the processor core for execution. The instructions can include compiled instructions. The ordered list can be presented to the processor by an operating system. In embodiments, the ordered list of instructions can be maintained in a circular queue. The circular queue can be implemented within the processor core, within memory, and so on. In embodiments, the circular queue comprises a reorder buffer within the processor core. The ordered list can be organized to facilitate access to the instructions within the ordered list. In the flow 100, the ordered list is organized 122 using one or more pointers. The one or more pointers can point to one or more addresses within the circular queue. In embodiments, the one or more pointers that are used to organize the ordered list can include a head pointer and a tail pointer within the circular queue. The head pointer can point to the earliest instruction added to the ordered list of instructions, while the tail pointer can point to the most recent instruction added to the ordered list. The head pointer can point to the instruction to be executed. Described below, the position of an instruction within the ordered list of instructions can be associated with an “age” of the instruction. In embodiments, the tail pointer can indicate a youngest, non-retired instruction in the ordered list of instructions. A non-retired instruction can include an instruction within the ordered list of instructions that is available for execution. In other embodiments, the head pointer can indicate an oldest, non-retired instruction in the ordered list of instructions. The flow 100 further includes coupling 124 a register in the processor core for storing an index related to the ordered list. The register can be used to store an index associated with a queue such as the circular queue, a list, and so on. The register can comprise a quantity of bits, nibbles, bytes, and so on. In embodiments, the register can include an eight-bit register.

In embodiments, entries in the ordered list can each comprise a plurality of instruction execution fields. The execution fields can include an opcode, an immediate address, an indirect or relative address, status bits, and so on. In embodiments, the index can include an address of an entry in the ordered list. The address can include a short address, where the address needs to contain enough bits to be able to address any entry within the ordered list. Discussed previously and throughout, in embodiments, the index can include an eight-bit address which can be stored in the eight-bit register.

The flow 100 includes detecting 130 an execution exception in the processor core. Discussed throughout, an execution exception can include a memory access exception such as a timeout, an arithmetic exception such as an arithmetic overflow, an undefined instruction exception, and so on. The detection of the exception can be based on an amount of time such as a number of processor cycles, an error indication such as a flag or message, and the like. In embodiments, the execution exception corresponds to one of the instructions in the ordered list. The execution exception can further be based on an attempt to execute a privileged instruction. In embodiments, the execution exception requires initiating an exception handling routine. The initiating the exception handling routine can include transferring execution from the instructions within the ordered list of instructions to instructions associated with the exception handling routine. In the flow 100, the detecting can delay initiating 132 the exception handling routine. The delay can be included to allow instructions that did not generate an execution exception to complete execution, to store valid data, and the like. In the flow 100, the detecting an execution exception in the processor core prevents execution 134 of any new instructions not already in the ordered list of instructions. The preventing execution can prevent damaging valid data, generating invalid data, and so on.

The flow 100 includes determining 140 an effective age of an instruction in the ordered list that corresponds to the execution exception. Determining the effective age of the instruction can determine which instruction within the ordered list of instructions caused the exception. Recall that the ordered list of instructions can be maintained in a circular queue. In embodiments, the effective age of an instruction can correspond to an address within the circular queue. The instruction can be positioned toward the head of the queue (older), in the middle of the queue, toward the tail of the queue (younger), etc. The effective age of the instruction can be based on the position of the instruction with the circular queue. The effective age can be based on matching. In embodiments, the match of the effective age of the instruction in the ordered list can be established by comparison to the head pointer. If the instruction is closer to the head of the queue, then the instruction is older. If the instruction is located near the tail of the queue, then the instruction is younger. In embodiments, the comparison comprises an “equal to” comparison. The “equal to” comparison can include equal to the head, equal to the tail, etc. In other embodiments, the comparison comprises a value of one less than the oldest, non-retired instruction in the ordered list of instructions. Note that an instruction within the ordered list of instructions can include multiple instruction execution fields. In embodiments, the effective age of an entry in the ordered list can be independent of all of the plurality of instruction execution fields. In embodiments, the accessing, the maintaining, the detecting, and the determining enable delaying the exception handling routine without using data stored in a reorder buffer. Discussed previously, the delaying the exception handling routine can enable instructions that did not cause the exception to complete and can allow processed data to be stored.

The flow 100 includes initiating 150 the exception handling routine. The exception handling routine that is initiated can include a general-purpose exception handling routine, an exception handling routine based on the type of exception that occurred, and so on. The initiating the exception handling routine can perform one or more operations. The operations can include saving a program counter (PC) or index to a register, noting the cause of the exception, disabling further exceptions or interrupts while the current exception is being processed, and so on. In the flow 100, the initiating the exception handling routine is based on matching 152 the effective age of an instruction in the ordered list with one of the one or more pointers. Described above, the effective age of an instruction can be determined relative to the head pointer or the tail pointer, can correspond to an address within the circular queue, and so on. The match of the effective age of an instruction is further based on an “equal to” comparison, a value of one less than the oldest, a non-retired instruction in the ordered list of instructions, etc. The flow 100 further includes retiring 154 older instructions from the ordered list of instructions. Since an instruction can be executed when data required by instruction becomes available, the instruction can be executed “out of order”. That is, the instruction that is executed may not necessarily be the next instruction within the ordered list of instructions. If the instruction that is executed out of order throws an exception, then older instructions (e.g., instructions loaded into the ordered list of instructions earlier than the instruction that threw the exception) can be retired. Retirement can include removing the older instructions from the ordered list of instructions after completion of their execution.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

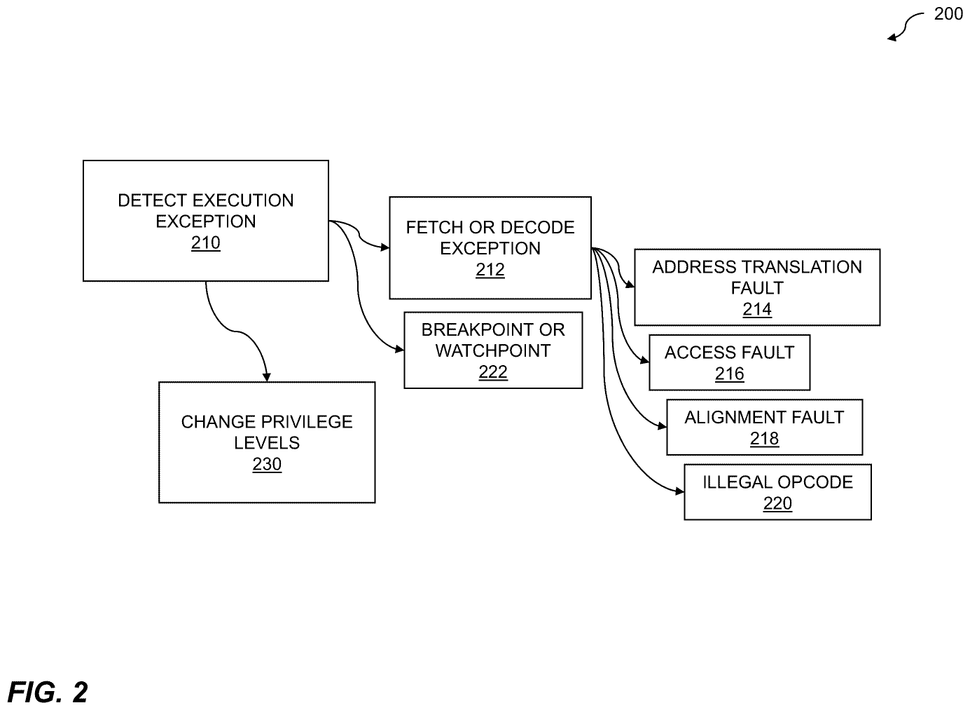

FIG. 2 is a flow diagram for exception handling. An exception can be detected within a processor as a result of execution of an instruction. The exception can include a timeout exception, where the instruction that is being executed is requesting data that is not loaded in time. The exception can result from an attempt to access a file that is nonexistent, to read data that is corrupted, and so on. The exception can result from an attempt to execute a privileged instruction. The code that is being executed may not have sufficient permission levels to run the privileged instruction, to access restricted data, etc. The exception handling supports processor instruction exception handling. A processor core is accessed, wherein the processor core executes at least one instruction thread, and wherein the processor core executes one or more instructions out of order. An ordered list of instructions is maintained, wherein the ordered list is based on instructions that are presented to the processor core for execution, and wherein the ordered list is organized using one or more pointers. An execution exception is detected in the processor core, wherein the execution exception corresponds to one of the instructions in the ordered list, and wherein the execution exception requires initiating an exception handling routine. An effective age of an instruction in the ordered list is determined. The effective age corresponds to the execution exception. The exception handling routine is initiated, based on matching the effective age of an instruction in the ordered list with one of the one or more pointers.

The flow 200 includes detecting 210 an execution exception in the processor core. The processor core can attempt to execute an instruction, but the instruction cannot be executed, fails to complete execution, and so on. Various types of exceptions can occur. Examples of execution exceptions include a storage access timeout, an arithmetic overflow, an illegal or unknown instruction being fetched for execution, a system call being executed, and so on. In embodiments, the execution exception corresponds to one of the instructions in the ordered list. An instruction can be accessed in the ordered list of instructions and the processor core can attempt to execute the instruction. The instruction may execute properly, or an exception as described above may occur. In the flow 200, the exception is related to a fetch or a decode exception 212. The fetch or decode exception can occur while fetching an instruction from the ordered list of instructions or decoding the instruction into decoded instruction packets. In the flow 200, the fetch or the decode exception can include an address translation fault 214. The address translation fault can result from the translated address not being located within the ordered list of instructions. In the flow 200, the fetch or the decode exception can include an access fault 216. The access fault can include a timeout, an illegal address, and so on. In the flow 200, the fetch or the decode exception can include an alignment fault 218. An exception can result during decode when a decoded instruction is too long, too short, incomplete, etc. In the flow 200, the fetch or the decode exception can include an illegal opcode 220. The illegal opcode can include an opcode not recognized for execution on the processor core. In the flow 200, the exception is related to a breakpoint or a watchpoint 222. The breakpoint or the watchpoint can be used for debugging code, monitoring code execution, verifying that execution successfully reaches a point in the code, etc. For fetch and/or decode exceptions, the detecting an execution exception can prevent execution of any new instructions not already in the ordered list of instructions.

In the flow 200, the exception handling routine changes 230 privilege levels in the processor core. Recall that detecting an execution exception can require initiating an exception handling routine. The exception handling routine can perform an action that can respond to the exception. The action can include halting or suspending execution of instructions such as instructions associated with a thread that is being executed by the processor core. Other actions in response to the execution exception can include execution instructions to resolve the problem that caused the exception, firing an alert, sending a message such as a system message, and the like. In order to respond to the exception, the exception handling routine may need to change privilege levels in order to execute the exception handling routine. In addition to halting or suspending execution, the exception handling routine can attempt to recover from the exception. The recovery from the exception can include retiring instructions from the ordered list of instructions.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

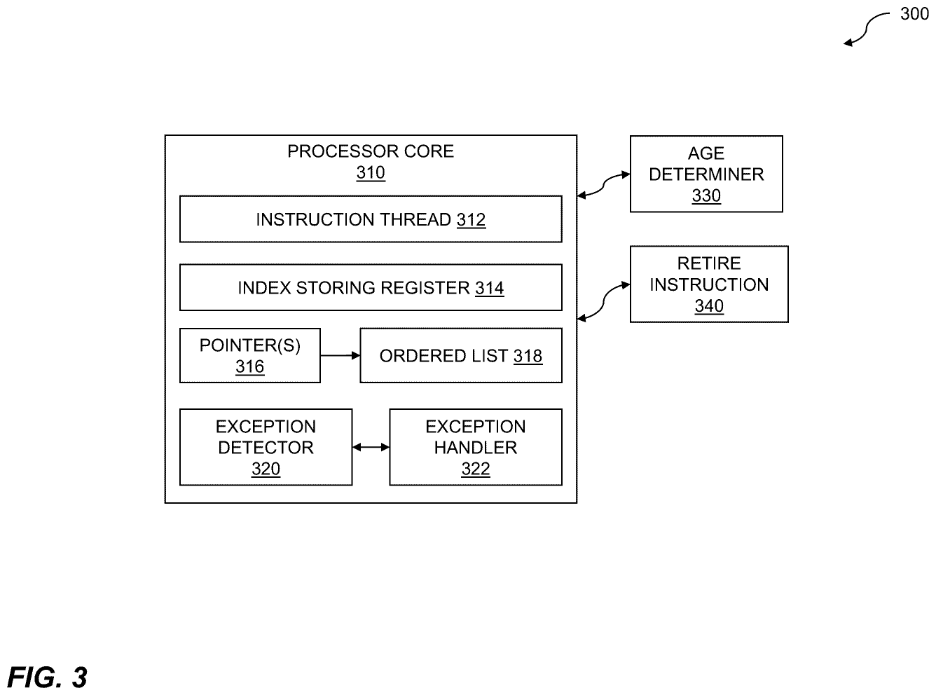

FIG. 3 is a system block diagram showing a processor core with exception handling. Instructions such as instructions associated with processing can be executed on a processor such as a processor core within an integrated circuit. The instructions can execute properly, or the instruction execution can generate an exception. The exception can include a memory access timeout, data not found, an invalid address, an attempt to execute a privileged instruction, and so on. Processor cores with exception handling enable processor instruction exception handling. A processor core is accessed, wherein the processor core executes at least one instruction thread, and wherein the processor core executes one or more instructions out of order. An ordered list of instructions is maintained, wherein the ordered list is based on instructions that are presented to the processor core for execution, and wherein the ordered list is organized using one or more pointers. An execution exception is detected in the processor core, wherein the execution exception corresponds to one of the instructions in the ordered list, and wherein the execution exception requires initiating an exception handling routine. An effective age of an instruction in the ordered list is determined. The age of the instruction corresponds to the execution exception. The exception handling routine is initiated, based on matching the effective age of an instruction in the ordered list with one of the one or more pointers.

The system block diagram 300 includes a processor core 310. The processor can include a multi-core processor, where two or more processor cores can be included. The processor, such as a RISC-V™ processor, can include a variety of elements that the processor can use to execute instructions. The elements can include one or more caches, memory protection and management units, local storage, and so on. The elements of the multicore processor can further include one or more of a private cache, a test interface such as a joint test action group (JTAG) test interface, one or more interfaces to a network such as a network-on-chip, shared memory, peripherals, and the like. The system block diagram 300 can include an instruction thread 312. The instruction thread can include a sequence of instructions that can be executed by a processor core. A thread can include a subset of instructions associated with a process such as a data processing process. The thread can be executed independently of one or more other instruction threads. The system block diagram 300 can include an index storing register 314. The register can be used to store an index associated with a queue, a list, and so on. Embodiments can include coupling a register in the processor core for storing an index related to the ordered list. The register can comprise a quantity of bits, nibbles, bytes, and so on. In embodiments, the register can include an eight-bit register.

The system block diagram can include one or more pointers 316. The one or more pointers can be used to access instructions, data, and so on. In embodiments, the one or more pointers are used to maintain an ordered list 318 of instructions. The pointers can be used to indicate the beginning of the ordered list, the end of the ordered list, and so on. A pointer can indicate a next instruction to be executed. In embodiments, the one or more pointers that are used to organize the ordered list comprise a head pointer and a tail pointer within the circular queue. The one or more pointers can be used to determine an age associated with an instruction within the ordered list of instructions (discussed below). In embodiments, the tail pointer can indicate a youngest or most recently loaded instruction in the ordered list of instructions. In other embodiments, the head pointer can indicate an oldest or least recently loaded instruction in the ordered list of instructions. The age associated with an instruction can be used to retire one or more instructions (discussed below).

The system block diagram 300 includes an exception detector 320. The exception detector can detect an execution exception in the processor core. Discussed above and throughout, an execution exception can result from a timeout such as a memory access timeout, a request for data that cannot be found or does not exist, an attempt to execute a privileged instruction by a process that does not have sufficient permission, and so on. In embodiments, the execution exception can correspond to one of the instructions in the ordered list. In embodiments, the exception can be related to a fetch or a decode exception. A fetch or decode exception can be associated with accessing an instruction, decoding the instructions into one or more instruction packets, and so on. In embodiments, the fetch or the decode exception can include an address translation fault, an access fault, an alignment fault, an illegal opcode, etc. The occurrence of an event such as an execution exception can cause an exception handling routine to be initiated. The system block diagram 300 includes an exception handler 322. The exception handler can initiate one or more exception handling routines. An exception handling routine can suspend, or halt, execution of instructions associated with an instruction thread. In embodiments, the detecting an execution exception in the processor core can prevent execution of any new instructions not already in the ordered list of instructions. The preventing execution of any new instructions can occur at least while the exception handling routine is executing.

The system block diagram 300 can include an age determiner 330. The age determiner can determine an instruction age, a relative instruction age, an effective instruction age, and so on. The instruction can include an instruction within the ordered list of instructions. In embodiments, the effective age of an instruction corresponds to an address within the circular queue, where the circular queue can maintain the ordered list of instructions. The effective age of an instruction can be determined based on a matching technique. In embodiments, the match of the effective age of the instruction in the ordered list can be established by comparison to the head pointer. The match can be based on an equality, an inequality, and so on. The system block diagram can include a retire instruction element 340. Instructions in the ordered list can be retired as a result of an occurrence of an execution exception. In a usage example, data can be requested as a result of executing an instruction within the ordered list of instructions. If the exception were a timeout exception, then the next instruction in line for execution would not be able to proceed because data required by the instruction is not available. Thus, the instruction can be retired.

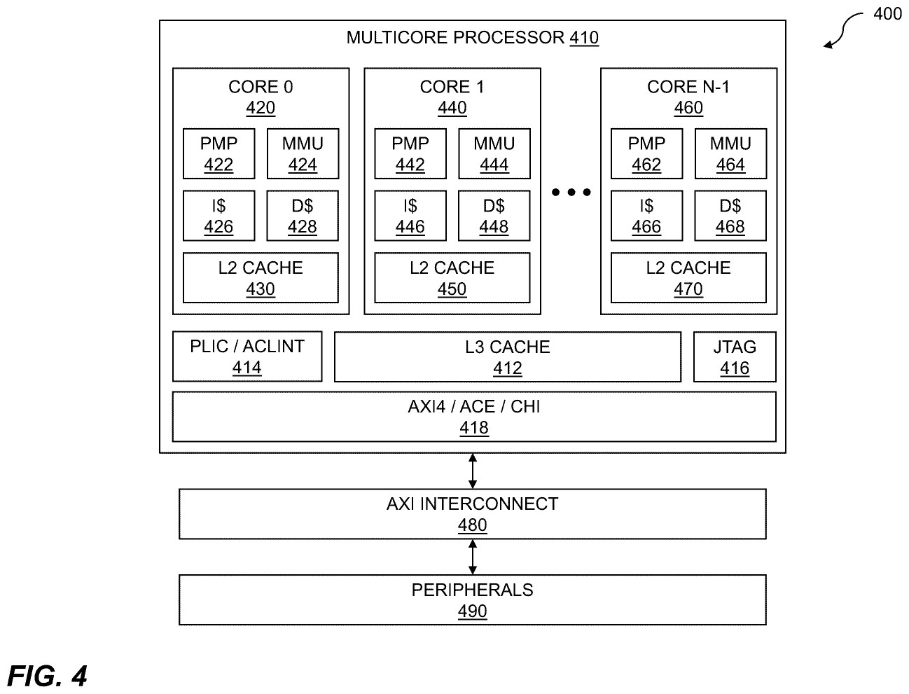

FIG. 4 is a block diagram illustrating a RISC-V™ processor. The processor can include a multi-core processor, where two or more processor cores can be included. The processor such as a RISC-V™ processor can include a variety of elements. The elements can include processor cores, one or more caches, memory protection and management units, local storage, and so on. The elements of the multicore processor can further include one or more of a private cache, a test interface such as a joint test action group (JTAG) test interface, one or more interfaces to a network such as a network-on-chip, shared memory, peripherals, and the like. The multicore processor is enabled by processor instruction exception handling. A processor core is accessed. The processor core executes at least one instruction thread, and the processor core executes one or more instructions out of order. An ordered list of instructions is maintained. The ordered list is based on instructions that are presented to the processor core for execution. The ordered list is organized using one or more pointers. An execution exception is detected in the processor core. The execution exception corresponds to one of the instructions in the ordered list. The execution exception requires initiating an exception handling routine. An effective age of an instruction in the ordered list is determined. The effective age corresponds to the execution exception. The exception handling routine is initiated, based on matching the effective age of an instruction in the ordered list with one of the one or more pointers.

The block diagram 400 can include a multicore processor 410. The multicore processor can comprise two or more processors, where the two or more processors can include homogeneous processors, heterogeneous processors, etc. In the block diagram, the multicore processor can include N processor cores such as core 0 420, core 1 440, core N−1 460, and so on. Each processor can comprise one or more elements. In embodiments, each core, including cores 0 through core N−1, can include a physical memory protection (PMP) element such as PMP 422 for core 0; PMP 442 for core 1, and PMP 462 for core N−1. In a processor architecture such as the RISC-V™ architecture, a PMP element can enable processor firmware to specify one or more regions of physical memory such as cache memory of the shared memory, and to control permissions to access the regions of physical memory. The cores can include a memory management unit (MMU) such as MMU 424 for core 0, MMU 444 for core 1, and MMU 464 for core N−1. The memory management units can translate virtual addresses used by software running on the cores to physical memory addresses with caches, the shared memory system, etc.

The processor cores associated with the multicore processor 410 can include caches such as instruction caches and data caches. The caches, which can comprise level 1 (L1) caches, can include an amount of storage such as 16 KB, 32 KB, and so on. The caches can include an instruction cache I$ 426 and a data cache D$ 428 associated with core 0; an instruction cache I$ 446 and a data cache D$ 448 associated with core 1; and an instruction cache I$ 466 and a data cache D$ 468 associated with core N−1. In addition to the level 1 instruction and data caches, each core can include a level 2 (L2) cache. The level 2 caches can include L2 cache 430 associated with core 0; L2 cache 450 associated with core 1; and L2 cache 470 associated with core N−1. The cores associated with the multicore processor 410 can include further components or elements. The further elements can include a level 3 (L3) cache 412. The level 3 cache, which can be larger than the level 1 instruction and data caches and the level 2 caches associated with each core, can be shared among all of the cores. The further elements can be shared among the cores. In embodiments, the further elements can include a platform level interrupt controller (PLIC) 414. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an advanced core local interrupter (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 416. The JTAG can provide a boundary within the cores of the multicore processor. The JTAG can enable fault information to a high precision. The high-precision fault information can be critical to rapid fault detection and repair.

The multicore processor 410 can include one or more interface elements 418. The interface elements can support standard processor interfaces including an Advanced extensible Interface (AXI™) such as AXI4™, an ARM™ Advanced extensible Interface (AXI™) Coherence Extensions (ACE™) interface, an Advanced Microcontroller Bus Architecture (AMBA™) Coherence Hub Interface (CHI™), etc. In the block diagram 400, the interface elements can be coupled to the interconnect. The interconnect can include a bus, a network, and so on. The interconnect can include an AXI™ interconnect 480. In embodiments, the network can include network-on-chip functionality. The AXI™ interconnect can be used to connect memory-mapped “master” or boss devices to one or more “slave” or worker devices. In the block diagram 400, the AXI interconnect can provide connectivity between the multicore processor 410 and one or more peripherals 490. The one or more peripherals can include storage devices, networking devices, and so on. The peripherals can enable communication using the AXI™ interconnect by supporting standards such as AMBA™ version 4, among other standards.

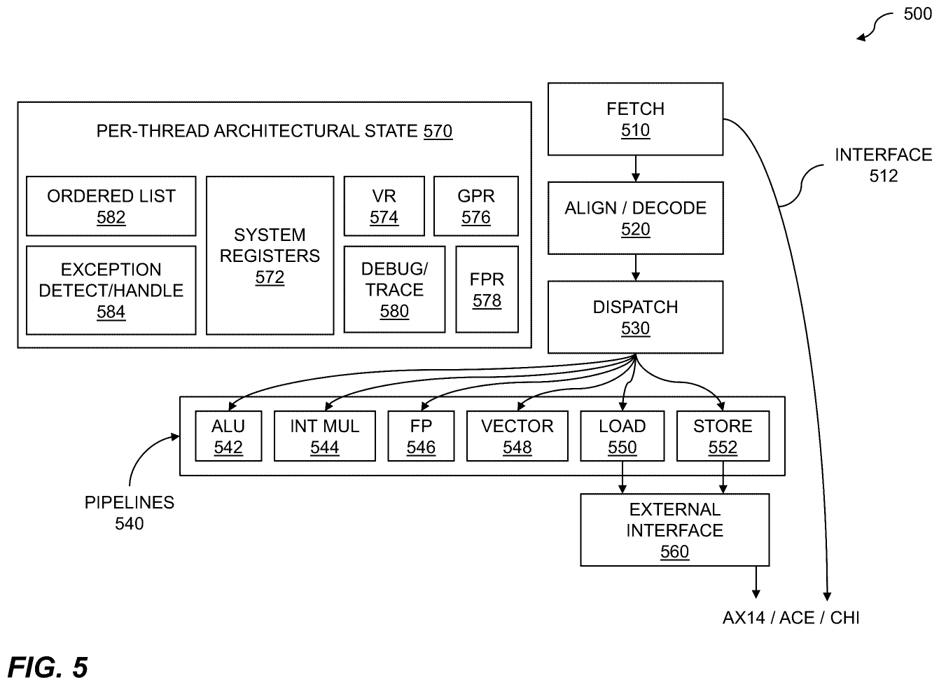

FIG. 5 is a block diagram for a pipeline. The use of one or more pipelines associated with a processor architecture can greatly enhance processing throughput. The processing throughput can be increased because multiple operations can be executed in parallel. One or more pipelines can be applied to specific processing tasks such as exception handling. The use of one or more pipelines supports processor instruction exception handling. A processor core is accessed, wherein the processor core executes at least one instruction thread, and wherein the processor core executes one or more instructions out of order. An ordered list of instructions is maintained, wherein the ordered list is based on instructions that are presented to the processor core for execution, and wherein the ordered list is organized using one or more pointers. An execution exception is detected in the processor core, wherein the execution exception corresponds to one of the instructions in the ordered list, and wherein the execution exception requires initiating an exception handling routine. An effective age of an instruction in the ordered list that corresponds to the execution exception is determined. The exception handling routine is initiated, based on matching the effective age of an instruction in the ordered list with one of the one or more pointers.

The FIG. 500 shows a block diagram of a pipeline such as a core pipeline. The blocks within the block diagram can be configurable in order to provide varying processing levels. The varying processing levels can be based on processing speed, bit lengths, and so on. The block diagram 500 can include a fetch block 510. The fetch block can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 512. The interface can include a standard interface such as one or more industry standard interfaces. The interfaces can include an Advanced extensible Interface (AXI™), an ARM™ Advanced extensible Interface (AXI™) Coherence Extensions (ACE™) interface, an Advanced Microcontroller Bus Architecture (AMBA™) Coherence Hub Interface (CHI™), etc.

The block diagram 500 includes an align and decode block 520. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decode packets. The decode packets can be used in the pipeline to manage execution of operations. The system block diagram 500 can include a dispatch block 530. The dispatch block can receive decoded instruction packets from the align and decode block. The decode instruction packets can be used to control a pipeline 540, where the pipeline can include an in-order pipeline, an out-of-order (OoO) pipeline, etc. For the case of an in-order pipeline, the dispatch block can maintain a register “scoreboard” and can forward instruction packets to various processors for execution. For the case of an out-of-order pipeline, the dispatch block can perform additional operations from the instruction set. Instructions can be issued by the dispatch block to one or more execution units. A pipeline can be associated with the one or more execution units. The pipelines associated with the execution units can include processor cores, arithmetic logic unit (ALU) pipelines 542, integer multiplier pipelines 544, floating-point unit (FPU) pipelines 546, vector unit (VU) pipelines 548, and so on. The dispatch unit can further dispatch instructions to pipelines that can include load pipelines 550, and store pipelines 552. The load pipelines and the store pipelines can access storage such as the common memory using an external interface 560. The external interface can be based on one or more interface standards such as the Advanced extensible Interface (AXI™). Following execution of the instructions, further instructions can update the register state. Other operations can be performed based on actions that can be associated with a particular architecture. The actions that can be performed can include executing instructions to update the system register state, to trigger one or more exceptions, and so on.

In embodiments, the plurality of processors can be configured to support multi-threading. The system block diagram can include a per-thread architectural state block 570. The inclusion of the per-thread architectural state can be based on a configuration or architecture that can support multi-threading. In embodiments, thread selection logic can be included in the fetch and dispatch blocks discussed above. Further, when an architecture supports an out-of-order (OoO) pipeline, then a retire component (not shown) can also include thread selection logic. The per-thread architectural state can include system registers 572. The system registers can be associated with individual processors, a system comprising multiple processors, and so on. The system registers can include exception and interrupt components, counters, etc. The per-thread architectural state can include further registers such as vector registers (VR) 574, general purpose registers (GPR) 576, and floating-point registers 578. These registers can be used for vector operations, general purpose (e.g., integer) operations, and floating-point operations, respectively. The per-thread architectural state can include a debug and trace block 580. The debug and trace block can enable debug and trace operations to support code development, troubleshooting, and so on. In embodiments, an external debugger can communicate with a processor through a debugging interface such as a joint test action group (JTAG) interface. The per-thread architectural state can include an ordered list state 582. An ordered list can include a list of instructions that can be executed in a given order. The ordered list can include list full, list empty, a head pointer, a tail pointer, etc. The per-thread architectural state can include an exception detection and handling state 584. The exception detection and handling state can include an exception such as a cache miss, memory access timeout, illegal operation, etc. The exception and handling state can include exception handling initiated, execution suspended, execution terminated, and the like.

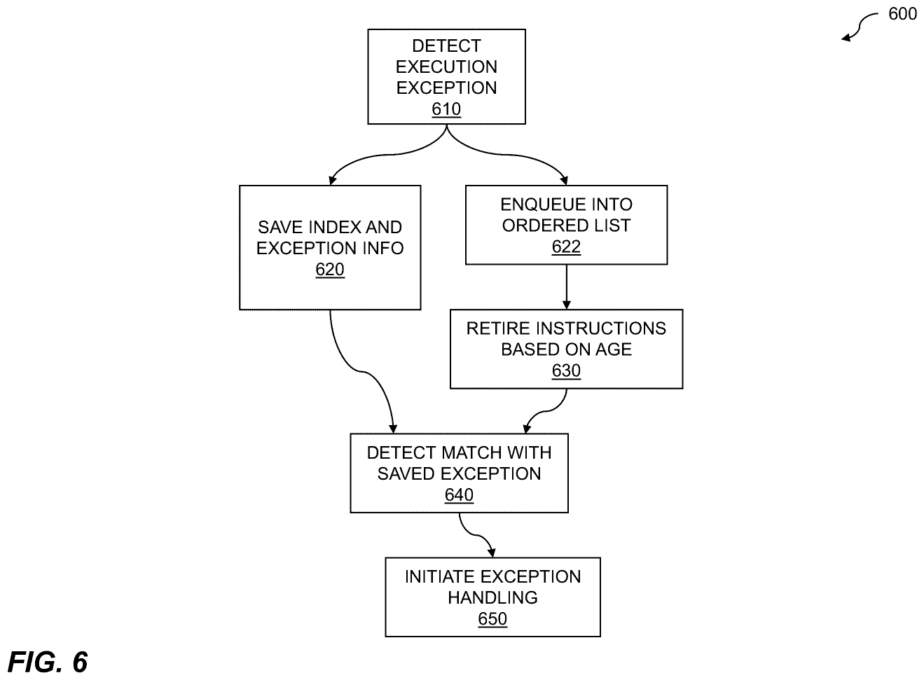

FIG. 6 is an example flow for instruction handling. Discussed above and throughout, a processor core can execute one or more instructions. The executed instructions can accomplish a processing objective such as data processing. The data processing can include data analysis, image or audio processing, artificial intelligence applications, and so on. An execution exception can occur when an anomalous or exceptional event occurs during execution of the one or more instructions. When an exception occurs, an exception handling routine can be initiated to determine the type of exception, techniques to handle the exception, and so on. Instruction handling enables processor instruction exception handling. A processor core is accessed. The processor core executes at least one instruction thread, and the processor core executes one or more instructions out of order. An ordered list of instructions is maintained. The ordered list is based on instructions that are presented to the processor core for execution. The ordered list is organized using one or more pointers. An execution exception is detected in the processor core. The execution exception corresponds to one of the instructions in the ordered list, and the execution exception requires initiating an exception handling routine. An effective age of an instruction in the ordered list is determined. The effective age corresponds to the execution exception. The exception handling routine is initiated, based on matching the effective age of an instruction in the ordered list with one of the one or more pointers.

The flow 600 includes detecting 610 an execution exception in the processor core. An execution exception can include a memory access exception such as invalid address, data not found, timeout, insufficient access permission, and so on. The execution exception can include attempting to execute a privileged instruction. In embodiments, the execution exception corresponds to one of the instructions in the ordered list. The instruction within the ordered list may cause a memory access exception or other exception. In other embodiments, the execution exception requires initiating an exception handling routine. Various actions can be taken, techniques applied, and so on by initiating the exception handling routine. In embodiments, the detecting an execution exception in the processor core can prevent execution of any new instructions not already in the ordered list of instructions. The execution exception can suspend execution of new instructions, halt execution, etc. In embodiments, the exception can be related to a fetch or a decode exception. The fetch operation can time out, or attempt access to a restricted or nonexistent location, an instruction that is successfully fetched can decode to an invalid or restricted instruction, etc. In embodiments, the fetch or the decode exception can include an address translation fault, an access fault, an alignment fault, an illegal opcode, and the like. Other exceptions can be triggered as part of debugging code, generating a restore point for the processor, etc. In embodiments, the exception can be related to a breakpoint or a watchpoint. The exception handling routine can capture a processor state, restore a processor state, correct execution errors, and so on. In embodiments, the exception handling routine can change privilege levels in the processor core. The change in privilege level can correct an access exception, can prevent damage from malicious code, and the like.

The flow 600 includes saving 620 an index related to the ordered list. The index related to the ordered list can indicate an address within a circular queue. Recall that the circular queue can be established in a circular buffer. Further embodiments can include coupling a register in the processor core for storing the index related to the ordered list. The “width” of the register can be based on the size of the ordered list. In embodiments, the index can include an address of an entry in the ordered list. The index can include a number of bits, where the number of bits can be based on the register coupled to the processor core. In embodiments, the register can include an eight-bit register.

The flow 600 can include enqueuing 622 the detected execution exception into an ordered list. Since instructions that are executed by the processor core can be “switched” from instructions previously loaded into the circular buffer to instructions associated with the exception handling, some instructions within the circular buffer may no longer be needed. The flow 600 can include retiring instructions 630 based on age. Recall that the one or more pointers that can be used to organize the ordered list can include a head pointer and a tail pointer. In embodiments, the tail pointer can indicate a youngest, non-retired instruction in the ordered list of instructions. In other embodiments, the head pointer can indicate an oldest, non-retired instruction in the ordered list of instructions. The age, such as an effective age of an instruction, can be associated with an address. In embodiments, the effective age of an instruction corresponds to an address within the circular queue.

The flow 600 includes detecting 640 a match with a saved exception. The match can be based on the effective age of an instruction, and the effective age of the instruction in the ordered list can be established by comparison to the head pointer. The comparison can be based on equality, inequality, and so on. In embodiments, the comparison can include an “equal to” comparison. The “equal to” comparison can be in relation to the head pointer. In other embodiments, the comparison can include a value of one less than the oldest, non-retired instruction in the ordered list of instructions. The flow 600 includes initiating the exception handling routine 650. The executing the exception handling routine can include executing the execution exception that was enqueued into the ordered list. In embodiments, the initiating the exception handling routine is based on matching the effective age of an instruction in the ordered list with one of the one or more pointers. The matching the effective age of the instruction can be used to determine which instruction within the ordered list caused the execution exception.

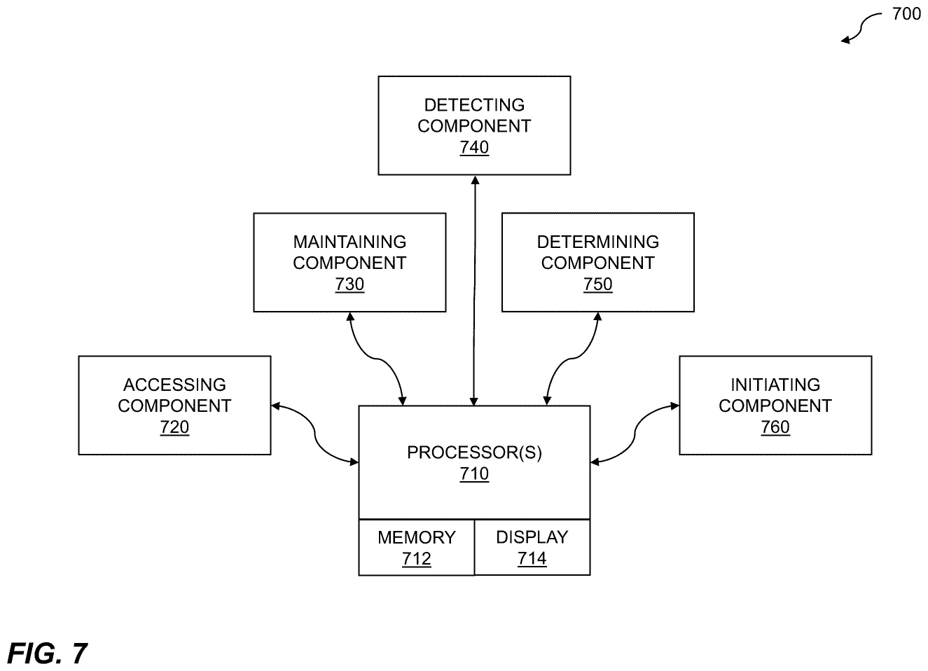

FIG. 7 is a system diagram for processor exception handling. The instruction execution is enabled by processor execution exception handling. The system can include one or more of processors, memories, cache memories, displays, and so on. The system 700 can include one or more processors 710. The processors can include standalone processors within integrated circuits or chips, processor cores in FPGAs or ASICs, and so on. The one or more processors 710 are coupled to a memory 712 which stores operations. The memory can include one or more of local memory, cache memory, system memory, etc. The system 700 can further include a display 714 coupled to the one or more processors 710. The display 714 can be used for displaying data, instructions, operations, and the like. The operations can include execution exception handling instructions. In embodiments, one or more processors 710 are coupled to the memory 712, wherein the one or more processors, when executing the instructions which are stored, are configured to: access a processor core, wherein the processor core executes at least one instruction thread, and wherein the processor core executes one or more instructions out of order; maintain an ordered list of instructions, wherein the ordered list is based on instructions that are presented to the processor core for execution, and wherein the ordered list is organized using one or more pointers; detect an execution exception in the processor core, wherein the execution exception corresponds to one of the instructions in the ordered list, and wherein the execution exception requires initiating an exception handling routine; determine an effective age of an instruction in the ordered list that corresponds to the execution exception; and initiate the exception handling routine, based on matching the effective age of an instruction in the ordered list with one of the one or more pointers.

The system 700 can include an accessing component 720. The accessing component 720 can access a processor core. More than one processor core can be accessed. The processor core can be accessed within one or more chips, FPGAs, ASICs, etc. In embodiments, the processor core can include RISC-V™ processor cores. The processor core can access further elements such as a common memory through a network such as a coherent network-on-chip. The common memory can include on-chip memory, off-chip memory, etc. In embodiments, the processor core can execute at least one instruction thread. The instruction thread can comprise one or more instructions. The instruction thread can be executed independently of one or more other instruction threads. In embodiments, the processor core can execute one or more instructions out of order. Out-of-order execution can enable execution of one or more instructions when data associated with the one or more instructions is available for processing. The out-of-order execution of instructions can improve overall performance of a processor core by reducing total elapsed execution time.

The system 700 can include a maintaining component 730. The maintaining component 730 can maintain an ordered list of instructions. The ordered list of instructions can include a portion of or all of instructions associated with an instruction thread. The ordered list is based on instructions that are presented to the processor core for execution. A variety of techniques can be used to organize the ordered list of instructions. In embodiments, the ordered list is organized using one or more pointers. The one or more pointers can point to registers, locations in storage such as a cache memory, a system memory, and so on. In embodiments, the ordered list of instructions can be maintained in a circular queue. The circular queue can be coupled to the processor core, accessible by the processor core, etc. In embodiments, the one or more pointers that are used to organize the ordered list can include a head pointer and a tail pointer within the circular queue. The head pointer can point to the next instruction to be executed, an instruction that has been in the queue the longest, and the like. In embodiments, the tail pointer can indicate a youngest, non-retired instruction in the ordered list of instructions. The youngest, non-retired (discussed below) instruction can include an instruction most recently loaded into the ordered list of instructions. In other embodiments, the head pointer can indicate an oldest, non-retired instruction in the ordered list of instructions. The attributions of “youngest” and “oldest” with reference to an instruction within the ordered list of instructions can be associated with an effective age of an instruction. In embodiments, the effective age of an instruction corresponds to an address within the circular queue. Determining the effective age of an instruction can be used to identify an instruction which caused an execution exception to occur.

The system 700 includes a detecting component 740. The detecting component 740 can detect an execution exception in the processor core. Discussed throughout, an execution exception can occur due to a timeout associated with storage access; requested data not found, missing, or corrupted; an illegal opcode; insufficient privilege to execute an instruction; and so on. In embodiments, the execution exception corresponds to one of the instructions in the ordered list. An exception can be related to an instruction fetch operation, an instruction decode operation, and the like. In embodiments, the fetch or the decode exception can include an address translation fault, an access fault, an alignment fault, or an illegal opcode. An exception can be associated with debugging code. In embodiments, the exception can be related to a breakpoint or a watchpoint. A breakpoint can halt execution of instructions at a given point within code, and a watchpoint can halt execution when a value of an expression changes. The detection of an execution exception can require initiating an exception handling routine (discussed below).

The system 700 includes a determining component 750. The determining component 750 can determine an effective age of an instruction in the ordered list that corresponds to the execution exception. The determining effective age can be accomplished using various techniques. In embodiments, the effective age of an instruction corresponds to an address within the circular queue, where the circular queue maintains the ordered list of instructions. The effective age of an instruction can be established by a comparison or match operation. In embodiments, the match of the effective age of the instruction in the ordered list can be established by comparison to the head pointer. The comparison can be based on an equality, an inequality, etc. In embodiments, the comparison can include an “equal to” comparison. The “equal to” comparison can be based on a number of bits, bytes, and so on. In other embodiments, the comparison can include a value of one less than the oldest, non-retired instruction in the ordered list of instructions.

The system 700 can include an initiating component 760. The initiating component 760 can initiate the exception handling routine, based on matching the effective age of an instruction in the ordered list with one of the one or more pointers. The exception handling routine can handle one or more types of exceptions. The types of exceptions can include memory access, debugging, intrusion, and other events that can cause the exceptions. In embodiments, the exception is related to a fetch or a decode exception. The fetch or decode exception can be associated with accessing instructions in a system memory, a cache memory, and so on. In embodiments, the fetch or the decode exception comprises an address translation fault, an access fault, an alignment fault, or an illegal opcode. The exception can further be based on an attempt to execute a privileged instruction without a sufficient permission level to do so. In other embodiments, the exception can be related to a breakpoint or a watchpoint. The breakpoint or the watchpoint can be used for code debugging, code execution monitoring, etc. In further embodiments, the exception handling routine can change privilege levels in the processor core. The changing privilege levels can be used to suspend or halt execution of instructions, to delete instructions, and so on. The execution of an exception handling routine can be delayed. In embodiments, the accessing, the maintaining, the detecting, and the determining can enable delaying the exception handling routine without using data stored in a reorder buffer.

The system 700 can include a computer program product embodied in a non-transitory computer readable medium for instruction execution, the computer program product comprising code which causes one or more processors to generate semiconductor logic for: accessing a processor core, wherein the processor core executes at least one instruction thread, and wherein the processor core executes one or more instructions out of order; maintaining an ordered list of instructions, wherein the ordered list is based on instructions that are presented to the processor core for execution, and wherein the ordered list is organized using one or more pointers; detecting an execution exception in the processor core, wherein the execution exception corresponds to one of the instructions in the ordered list, and wherein the execution exception requires initiating an exception handling routine; determining an effective age of an instruction in the ordered list that corresponds to the execution exception; and initiating the exception handling routine, based on matching the effective age of an instruction in the ordered list with one of the one or more pointers.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for instruction execution comprising:
accessing a processor core, wherein the processor core executes at least one instruction thread, and wherein the processor core executes one or more instructions out of order;
maintaining an ordered list of instructions, wherein the ordered list is based on instructions that are presented to the processor core for execution, and wherein the ordered list is organized using one or more pointers;
detecting an execution exception in the processor core, wherein the execution exception corresponds to one of the instructions in the ordered list, and wherein the execution exception requires initiating an exception handling routine;
determining an effective age of an instruction in the ordered list that corresponds to the execution exception; and
initiating the exception handling routine, based on matching the effective age of an instruction in the ordered list with one of the one or more pointers.

2. The method of claim 1 wherein the ordered list of instructions is maintained in a circular queue.

3. The method of claim 2 wherein the one or more pointers that are used to organize the ordered list comprise a head pointer and a tail pointer within the circular queue.

4. The method of claim 3 wherein the tail pointer indicates a youngest, non-retired instruction in the ordered list of instructions.

5. The method of claim 3 wherein the head pointer indicates an oldest, non-retired instruction in the ordered list of instructions.

6. The method of claim 5 wherein the effective age of an instruction corresponds to an address within the circular queue.

7. The method of claim 6 wherein the match of the effective age of the instruction in the ordered list is established by comparison to the head pointer.

8. The method of claim 7 wherein the comparison comprises an “equal to” comparison.

9. The method of claim 7 wherein the comparison comprises a value of one less than the oldest, non-retired instruction in the ordered list of instructions.

10. The method of claim 7 wherein the circular queue comprises a reorder buffer within the processor core.

11. The method of claim 1 further comprising coupling a register in the processor core for storing an index related to the ordered list.

12. The method of claim 11 wherein entries in the ordered list each comprise a plurality of instruction execution fields.

13. The method of claim 12 wherein the effective age of an entry in the ordered list is independent of all of the plurality of instruction execution fields.

14. The method of claim 11 wherein the index comprises an address of an entry in the ordered list.

15. The method of claim 11 wherein the register comprises an eight-bit register.

16. The method of claim 1 wherein the execution exception is related to a fetch or a decode exception.

17. The method of claim 16 wherein the fetch or the decode exception comprises an address translation fault, an access fault, an alignment fault, or an illegal opcode.

18. The method of claim 16 wherein the detecting an execution exception in the processor core prevents execution of any new instructions not already in the ordered list of instructions.

19. The method of claim 1 wherein the exception is related to a breakpoint or a watchpoint.

20. The method of claim 1 wherein the exception handling routine changes privilege levels in the processor core.

21. The method of claim 1 wherein the accessing, the maintaining, the detecting, and the determining enable delaying the exception handling routine without using data stored in a reorder buffer.

22. A computer program product embodied in a non-transitory computer readable medium for instruction execution, the computer program product comprising code which causes one or more processors to perform operations of:
accessing a processor core, wherein the processor core executes at least one instruction thread, and wherein the processor core executes one or more instructions out of order;
maintaining an ordered list of instructions, wherein the ordered list is based on instructions that are presented to the processor core for execution, and wherein the ordered list is organized using one or more pointers;
detecting an execution exception in the processor core, wherein the execution exception corresponds to one of the instructions in the ordered list, and wherein the execution exception requires initiating an exception handling routine;
determining an effective age of an instruction in the ordered list that corresponds to the execution exception; and
initiating the exception handling routine, based on matching the effective age of an instruction in the ordered list with one of the one or more pointers.

23. A computer system for instruction execution comprising:
a memory which stores instructions;
one or more processors coupled to the memory wherein the one or more processors, when executing the instructions which are stored, are configured to:
access a processor core, wherein the processor core executes at least one instruction thread, and wherein the processor core executes one or more instructions out of order;
maintain an ordered list of instructions, wherein the ordered list is based on instructions that are presented to the processor core for execution, and wherein the ordered list is organized using one or more pointers;
detect an execution exception in the processor core, wherein the execution exception corresponds to one of the instructions in the ordered list, and wherein the execution exception requires initiating an exception handling routine;
determine an effective age of an instruction in the ordered list that corresponds to the execution exception; and
initiate the exception handling routine, based on matching the effective age of an instruction in the ordered list with one of the one or more pointers.
